(19) United States
(12) Patent Application Publication
(10) Pub. No.: US 2002/0156739 A1
(43) Pub. Date: Oct. 24, 2002

(54) Navigation apparatus and program

(76) Inventors: Kazumichi Hirai, Okazaki (JP); Keiji Kazahaya, Okazaki (JP); Satoshi Ogawa, Okazaki (JP)

Correspondence Address: LORUSSO & LOUD, 3137 Mount Vernon Avenue, Alexandria, VA, 22305, US

(21) Appl. No.: 10/108,304

(22) Filed: Mar. 28, 2002

(30) Foreign Application Priority Data
Mar. 30, 2001 (JP) 2001-100631
Apr. 17, 2001 (JP) 2001-118863
Apr. 17, 2001 (JP) 2001-118865

(51) Int. Cl. G06F 17/60

(52) U.S. Cl. 705/52; 705/26

(57) ABSTRACT

The disclosed system reduces map data use fees by allowing a user to use only that map data for a certain area that includes information useful to the user, and allows a map data provider to expand map data use areas. The disclosed system includes a navigation apparatus which performs navigation processing based on stored map data and which is provided with an information storage device for storing map data, and a central processing unit for setting part of the map data as an open area defined by a rectangle.

### INCORPORATION BY REFERENCE

The teachings of Japanese Application No. 2001-100631, filed Mar. 30, 2001, Japanese Application No. 2001-118863, filed Apr. 17, 2001 and Japanese Application No. 2001-118865, filed Apr. 17, 2001 are incorporated herein in their entirety, inclusive of the specification, claims and drawings.

### BACKGROUND OF THE INVENTION

1. Field of the Invention

The present invention relates to a navigation apparatus and to a storage medium with an encoded program which allows a user to use only that portion of stored map data that is immediately useful to the user.

2. The Prior Art

Previously, navigation apparatus having route search and route guide guidance functions used map data that was stored on CDs and a user purchased a certain number of CDs corresponding to a map area in which he intended to travel. However, in recent years, larger capacity storage devices such as the DVD have been developed and such storage devices containing map data have come to be incorporated into navigation apparatus. A single DVD can store data for a large area such as map data for the entirety of Japan or the entirety of Europe.

However, navigation systems designed to assist driving must accommodate different ranges of movement of different users dependent on various geographical and personal factors. Therefore, a small-capacity database cannot be universally satisfactory to a large number of users. Therefore, demand for a database containing universal information has led to adoption of the DVD as a storage medium capable of satisfying such a requirement by greatly increasing the database capacity. However, with increase in database capacity attained by the use of the DVD, the cost of development of databases has also increased. Moreover, a database containing such universal information includes not only information useful to the user, but also information of no use to the user. Therefore, for the user who uses only a part of the data, the DVD selling price is unnecessarily expensive and this expensive price is an obstacle to market expansion of DVD use.

### SUMMARY OF THE INVENTION

The present invention has as its objectives the lowering of map data selling price by allowing a user to use only that map data for a limited area which is useful to him and to allow a map data provider to expand map data use areas.

To attain the above objectives, the present invention provides a method for accessing map data for navigation, wherein all or part of available map data is opened for use in providing navigational guidance based on map data access right information.

The invention also provides an accounting system for fees for map data input to a navigation apparatus, wherein the use fees vary depending on the area of map data used.

The invention further provides a storage medium with an encoded program which generates identification information unique to a navigation apparatus based on a map data use range, identification information unique to the navigation apparatus, and map data edition information, and controls the area of map data opened, based on map data access right information that is generated based on the unique identification information.

Thus, the invention provides a navigation system which provides navigational guidance based on stored map data, and which includes:

a navigation apparatus comprising storage means for storing map data; means for inputting area information indicating map data to be released; means for sending the area information and identification information, unique to the navigation apparatus, to a remote information center; and means for receiving information from the information center;

wherein the information center includes means for receiving the area information and the identification information, unique to the navigation apparatus, from the navigation apparatus; and means for generating data access right information based on the received area information and identification information unique to the navigation apparatus,

wherein the navigation apparatus opens, for use in providing the navigational guidance, all or part of the map data based on the data access right information received from the information center.

The present invention also provides a navigation method for providing navigational guidance based on stored map data, comprising:

receiving, at the navigation apparatus, area information indicating map data to be opened, and sending the area information and identification information unique to the navigation apparatus to a remote information center; at the remote information center, receiving the area information and the identification information unique to the navigation apparatus from the navigation apparatus; at the remote information center, generating data access right information based on the received area information and identification information unique to the navigation apparatus, and sending the generated data access right information to the navigation apparatus; and, at the navigation apparatus opening map data, for use in providing navigational guidance, based on the data access right information received from the remote information center.

The invention also provides an information center which sends and receives data to and from a navigation apparatus, including means for receiving area information and identification information unique to the navigation apparatus from the navigation apparatus; means for generating, based on the received area information and identification information unique to the navigation apparatus, data access right information to be used for opening map data to use in the navigation apparatus; and means for sending the generated data access right information to the navigation apparatus.

The invention further provides a navigation apparatus which provides navigational guidance based on stored map data, which apparatus includes: means for inputting area information indicating map data to be opened for use in providing the navigational guidance; means for sending the area information and identification information unique to the navigation apparatus to a remote information center; means for receiving, from the information center, data access right information that has been generated based on the area information and the identification information unique to the navigation apparatus; and means for opening map data based on the data access right information.

The invention also provides a navigation apparatus which performs navigation guidance based on stored map data, and which includes storing means for storing map data and area setting means for setting part of the map data as an open rectangular area.

The invention also provides a navigation apparatus which performs navigation processing based on stored map data, comprising storing means for storing map data; fee setting means for setting a use fee for use of the map data; and area setting means for setting, as an open area, part of the map data of a range corresponding to the use fee.

The invention further provides a navigation apparatus which provides navigational guidance based on stored map data, including storing means for storing map data for a plurality of respective areas; and area setting means for setting a map-data-open area by selecting areas of a number corresponding to a use fee.

Further, the invention provides a terminal for data transmission to and from a remote information center, including data identifying the navigation apparatus unit; means for inputting map-data-open area information; means for transmitting the identifying information and the area information to the information center; and means for receiving, from the information center, data access right information based on the identifying information and the area information.

The invention also provides a terminal for data transmission to and from a remote information center and a navigation apparatus. In this embodiment, the terminal includes means for receiving information identifying a particular navigation apparatus from a navigation apparatus; means for inputting map-data-open area information; means for transmitting the identifying information and the area information to the information center; and means for receiving data access right information based on the identifying information and the area information from the information center.

The invention also provides a storage medium with an encoded program for generation of navigational guidance based on stored map data, wherein the program opens only a limited portion of the stored map data as a map,-data-open rectangular area.

The invention also provides a storage medium with an encoded program for map display based on stored map data, wherein the program opens only a limited portion of the stored map data as a map-data-open rectangular area.

### BRIEF DESCRIPTION OF THE DRAWINGS

FIG. 1 is a block diagram showing one embodiment of a navigation system according to the present invention;

FIG. 2 illustrates a map divided into respective areas for map data;

FIG. 3 shows an area expansion menu picture;

FIG. 4A is a flowchart of an area opening routine;

FIG. 4B is a flowchart of another area opening routine;

FIG. 5 represents a map of Europe;

FIG. 6 shows the setting of a data-open area as a rectangular region;

FIG. 7 shows an example in which the entire area is divided in advance and a use area is selected from among the divisions;

FIG. 8 shows an example in which boundaries of administrative districts are made to define open data area boundaries;

FIG. 9 is a flowchart of an example of a routine in which a warning is given before facility information is displayed for guidance;

FIG. 10 is a flowchart of an example of a routine in which a warning is given while only a part of facility information is displayed;

FIG. 11 is a flowchart of an example of a routine in which a warning is given after all facility information has been displayed;

FIG. 12 is a flowchart of an example of a routine in which an area check is performed after a destination search and first voice guidance;

FIG. 13 is a flowchart of an example of a routine in which an area check is performed after a destination search;

FIG. 14 is a flowchart showing an example of a routine in which a judgment is made as to whether data to be read into the navigation apparatus is located inside or outside the open area before the data is read into the apparatus;

FIG. 15 is a flowchart of an example of a routine in which guidance information is provided only when the user's vehicle is located inside the open area;

FIG. 16 is a flowchart of an example of a routine in which a determination is made as to whether the coordinates of a voice output point are located inside or outside the open area and whether to output voice guidance is controlled based on the result of that determination;

FIG. 17 illustrates a specific example of execution of the routine of FIG. 16;

FIG. 18 illustrates an example of execution in the case where a route obtained by a search includes a section that is located outside an open area, and a further search is performed by using only the map data for the open area; and

FIG. 19 is a block diagram of one embodiment of a navigation apparatus according to the present invention.

### DESCRIPTION OF THE PREFERRED EMBODIMENTS

An embodiment of the present invention will be hereinafter described with reference to the drawings.

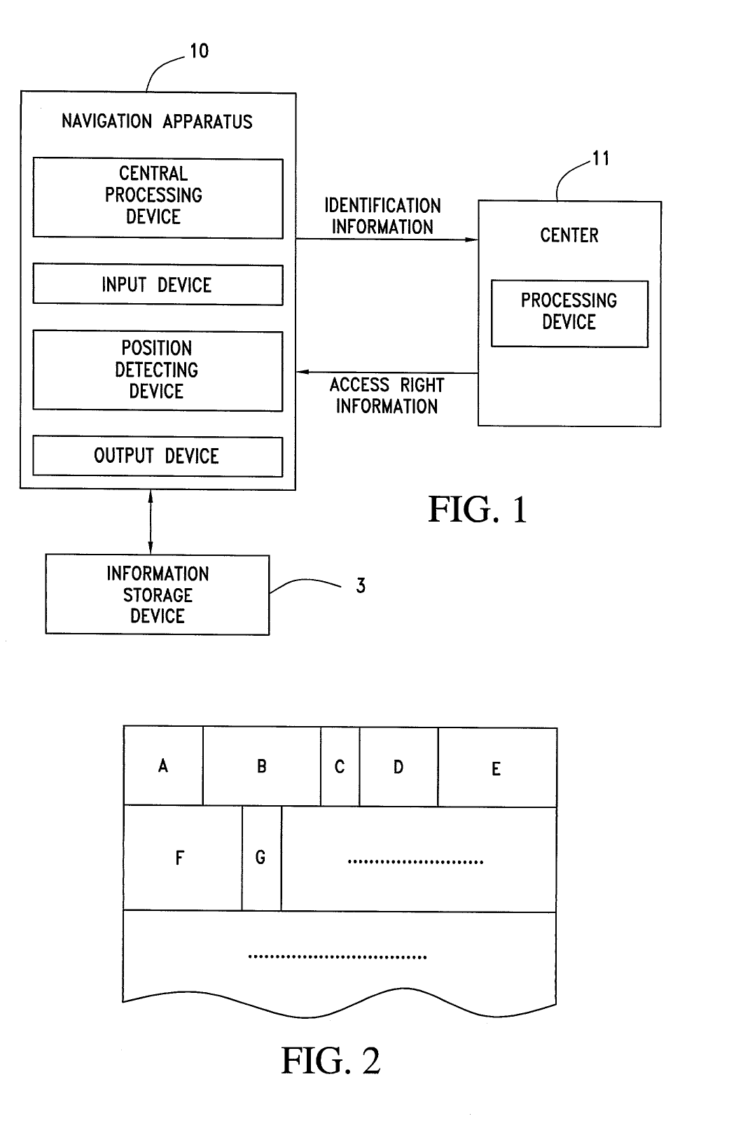

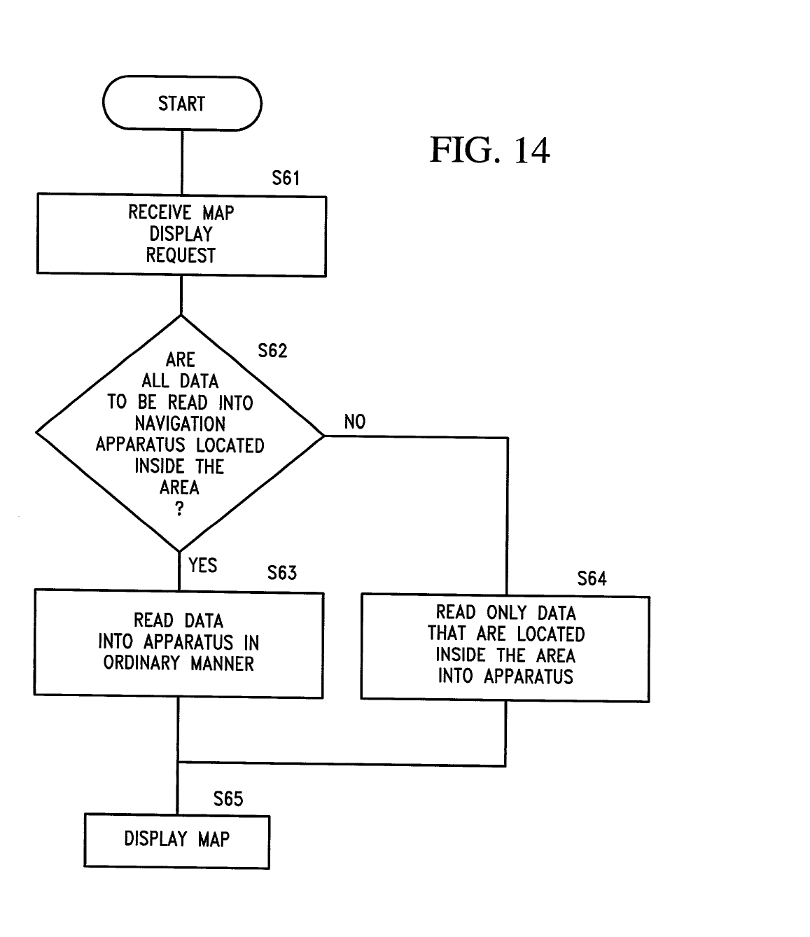

Referring first to FIGS. 1 and 2 a large-capacity information storage device, such as a DVD, 3 contains all map data that users would ordinarily use such as map data for the entirety of Japan or Europe, information (facility data) for facilities such as restaurants and gas stations, search data to be used for route searching, guide data to be used for route guidance, and other data. A navigation apparatus 10 is provided with a central processing unit 10A, an input device 10B, a position detecting device 10C, an output device 10D, etc. The central processing unit 10A has programs for all navigation purposes, including but not limited to programs for executing the routines corresponding to the flowcharts of FIGS. 14 and 16, as well as data to be used in running those programs. When the user inputs a destination through the input device, the central processing unit 10A reads map data from the information storage device 3, searches for a route from a present position, that has been detected by the position detecting device or a start point that has been input through the input device, to the destination, and guides the user through the output device. Composed of a display, a speaker, etc., the output device can provide guidance in the forms of both a visual display and voice.

In the navigation apparatus 10 according to this embodiment, within the map database stored in the information storage device 3, only that data for areas desired by the user are rendered open (i.e., rendered usable by the navigation apparatus 10) and the data for the other areas cannot be accessed. A use fee is determined in accordance with data-usable areas. An area-dependent fee may be determined in various manners. For example, area sizes may be classified into large, medium, and small and a use fee for an area is determined depending on which of those categories the area(s) of interest are within. Alternatively, weights are given to fees of respective areas and the sum of fees for the selected areas is the use fee. In yet another alternative, the same fee is set for every area and a use fee is determined simply by the number of areas selected. Where the map data stored in the information storage device 3 is divided into area A, area B, area C, etc., as shown in FIG. 2, and a uniform fee α is set for every area, a use fee is determined as nα where n is the number of areas selected. Where different fees are set for respective areas, the fee for each area may be set in accordance with the amount of map data or the square measure of the area.

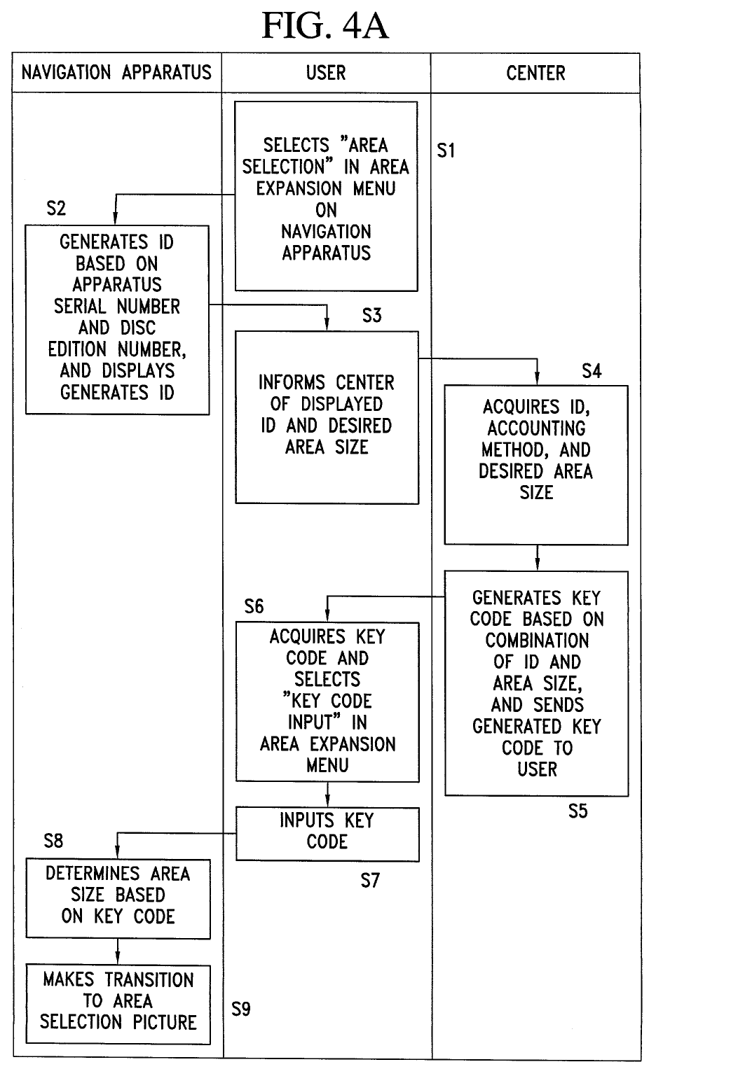

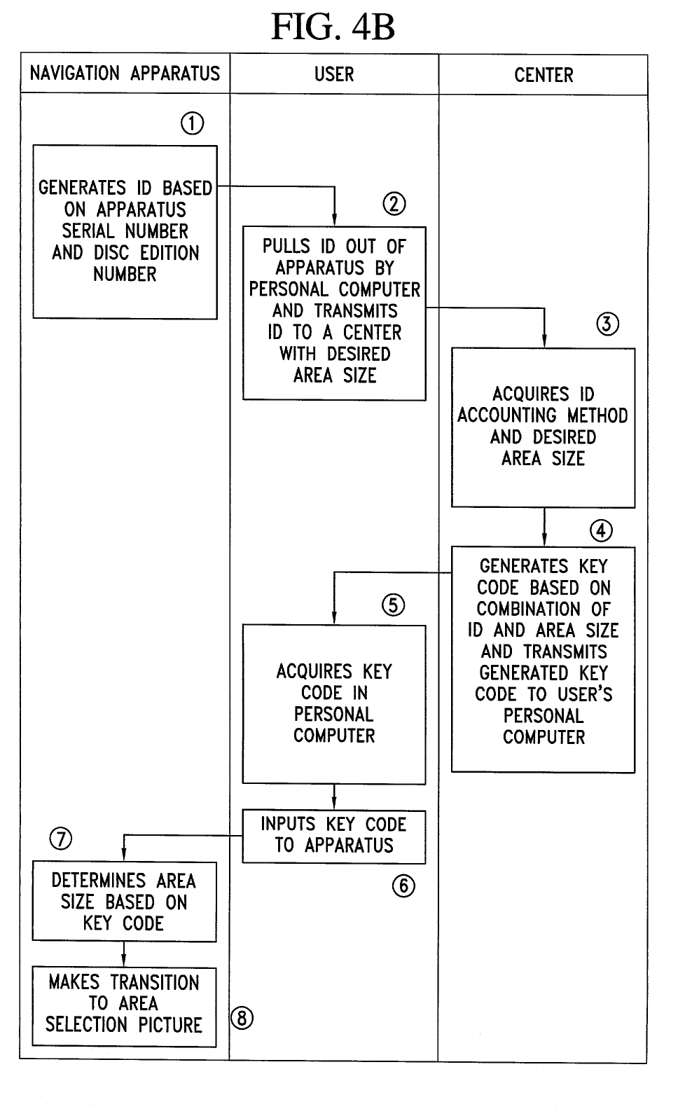

For example, when the user purchases a new navigation apparatus 10, a prescribed area (e.g., three countries in Europe) can be selected in accordance with its base price. In this case, when the user selects an arbitrary area after purchasing the navigation apparatus 10, the map data for the selected area(s) is rendered open. The price of the navigation apparatus 10 may be set in accordance with the amount of area for which data can be initially used. For example, a price may be set depending on whether the area size is large (seven countries), medium (five countries), or small (three countries). Subsequently, if there is a region that is outside the initially available area for which the user would like to use the navigation apparatus 10 frequently and therefore wants to expand the area from the initially selected area, the area open process shown in FIG. 4A and FIG. 4B may be executed. In another approach, the price of a newly purchased navigation apparatus 10 would not include the price of map data and the user would subsequently purchase map data for an arbitrary area by utilizing the area open process shown in FIG. 4A and FIG. 4B.

With the system of the present invention, it is necessary to prevent illegal use of map data. To this end, in this embodiment, the navigation apparatus 10 itself, more specifically, its central processing unit 10A, generates its own identification information (ID) based on a combination of a serial number (e.g., a product number) unique to the hardware of the navigation apparatus 10 and the number (an edition number of the map data) of a disc containing map data that is mounted in the navigation apparatus 10. For example, where the navigation apparatus 10 has a certain function f and the above-mentioned serial number and the edition number of map data are n and m, respectively, the central processing device generates an ID number in the following manner:

ID=f(n,m)

If a price is determined by an area size, the navigation apparatus 10 sends a remote information center 11 a desired area size s together with the ID. The navigation apparatus 10 has an area input (setting) means through which an area size may be input in the form of “large,” “medium,” “small,” a number of countries, or the like. Alternatively, an area may be specified as “Germany, France, and Belgium,” for example, when the user sends the ID to the information center 11.

Having a function g, the information center 11 generates a key code (map data access right information) k based on the ID and the area size s according to:

k=g(ID,s)

The information center 11 (more specifically, a processing unit in the information center 11) has means for acquiring the ID generated by the navigation apparatus 10 and the area size as well as means (central processing unit) for generating a key code based on the acquired ID and area size. An accounting method (e.g., use of a credit card) is stored in the information center 11, and the information center 11 has a means (central processing unit) for settlement of the account according to the accounting method using the key code. When the generated key code is sent to the user, accounting processing is performed. Further, this accounting processing may be so performed that the individual users are identified with an IC card, e.g. UIM (SIM) card, which permits global roaming.

The key code includes the area size information. When the key code is input to the navigation apparatus 10, map data is opened by a program that has been read into the central processing unit. For example, where the key code is used as an area size open key, an area selection screen is displayed upon input of the key, to allow the user to select an area (e.g., three countries). When the user selects an area, the map data for the selected area is opened. Where the key code is used as a key for opening an area that was input through the area input means, the previously input area is opened in the navigation apparatus 10 upon input of the key.

In the system having the above configuration, another navigation apparatus cannot use even map data of the same edition number because it has a different serial number. The above-described area expansion process can be performed whenever the disc is used. When a new disc is purchased, a key code is again generated by the above-described method.

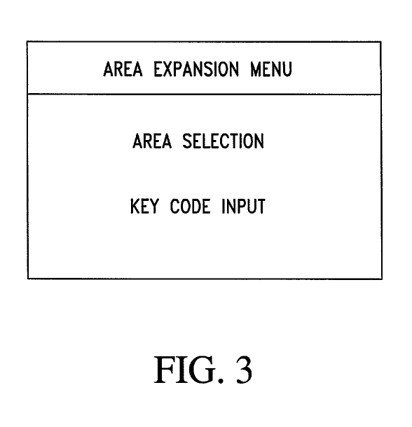

To enable the above-described area expansion, the navigation apparatus 10 prepares an area expansion menu as shown in FIG. 3. If “area selection” is selected, the navigation apparatus 10 generates an ID automatically by reading its serial number that is set, for example, in a flash ROM and the disc number of the information storage device 3. If “key code input” is selected from this menu display and a key code that has been sent from the information center 11 is input, an area size is determined based on the key code and the corresponding map data is opened (made available for use in the navigation apparatus).

Management may be performed within the information center. In this case, the information center 11 manages the serial numbers of navigation apparatuses, map data edition numbers, etc. When a user inputs a user ID (may not relate to a serial number or an edition number) and an area size, the information center 11 searches for a serial number of a navigation apparatus and a map data edition number that correspond to the user ID and generates a key code. Further, the information center 11 may store and manage information for areas having map data currently open to the user (data for which user fees have been paid by users), and propose (send a proposal) another area when receiving an open request from a user. That is, the information center 11 may positively urge a user to make a selection (particularly in the case where the price depends on the area size).

Next, area opening according to one embodiment will be described with reference to FIG. 4A.

First, the area expansion menu of the navigation apparatus 10 is displayed and “area selection” is selected (step S1). The navigation apparatus 10 generates an ID based on a hardware serial number and a disc edition number and displays the generated ID on the screen (step S2). The user informs the information center 11 of the displayed ID and a desired area size (step S3). If the navigation apparatus 10 has a communication means, these pieces of information may be sent to the information center 11 by electronic communication. Alternatively, if the navigation apparatus 10 is connectable to a terminal (a electronic device), such as a personal computer, a cellular phone, or a PDA, the pieces of information may be sent to the center 11 through use of the terminal. The information center 11 acquires the ID of the navigation apparatus 10, an accounting method, and the desired area size (step S4), and generates a key code based on the ID and the area size (step S5). The generated key code is sent to the user. Receiving the key code, the user opens the area expansion menu display and selects “key code input” (step S6) and then inputs the key code (step S7). If the information center 11 has a key code transmitting means and the key code from the communication means in the navigation apparatus 10 is received at the information center 11, the received information is incorporated into the navigation apparatus 10. If the key code is received by a personal computer, a cellular phone, or PDA, the received information is thereby input into the navigation apparatus 10. The navigation apparatus 10 determines an area size based on the inputted key code (step S8), and makes a transition to the area selection display to open the selected area from said area size (step S9). This area opening process is directed to the case that a key code includes an area size. Where a key code includes information indicating a specific area (e.g., Germany, France, or the like), the specified area is opened upon acquisition of the key code.

This area open process may also be executed between the navigation apparatus 10 and a personal computer, a cellular phone, or a PDA, here exemplified by a personal computer. While a personal computer is exemplified, a cellular phone or a PDA may be substituted for the personal computer.

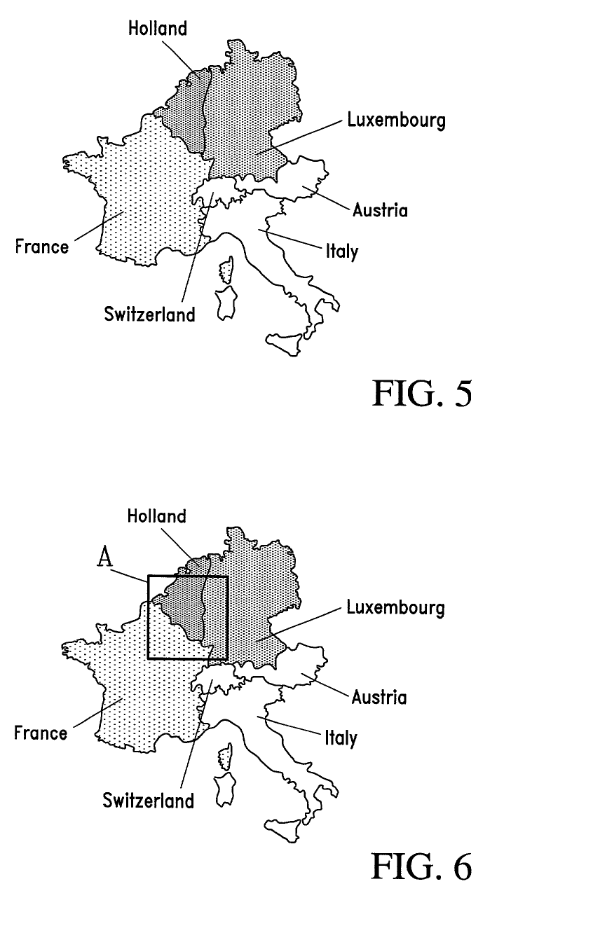

In the routine of FIG. 5, the navigation apparatus 10 first generates an ID based on a hardware serial number and a disc edition (step S1). Then, the user integrates the ID pulled out of the apparatus 10 into a personal computer, and informs the information center 11 of the ID and a desired area size (step S2). Of course, the user may alternatively directly input the ID into the personal computer. When the ID is received by a data processor in the information center 11, an accounting program, and the desired area size are acquired (step S3), and a key code based on the ID and the area size is generated to be sent to the personal computer used by the user (step S4). When the key code is received in the personal computer (step S5), the user inputs the key code from the personal computer to the navigation apparatus 10 (step S6). The navigation apparatus 10 determines the area size based on the inputted key code (step S7), and displays the area selection screen for opening the selected area from the area size (step S8). In using the area opening process, it is possible to acquire the key code and designate the area size even when the user is remote from the vehicle. While the ID is generated in the navigation apparatus 10 in the above case, a personal computer, cellular phone, or PDA, loaded with a program for generating the ID, may directly generate the ID and transmit it to the information center 11.

When employing a personal computer, cellular phone, or PDA in the area opening process, the aforementioned IC card, e.g., SIM card, is inserted into the navigation apparatus 10, personal computer, cellular phone, or PDA, thereby enabling data communication between the navigation apparatus 10 and the information center 11.

In the above example, data exchange between the navigation apparatus 10 and the information center 11 is performed manually. Area map data which the user wants to use can be selected more easily when a server or a customer server on the Internet serves as the information center 11. If a user owns a plurality of identical navigation apparatuses and wants to use the same disc in these navigation apparatuses, map data may be provided free of charge within the confines of up to two (or three) apparatuses, for example. In this case, when the ID of the first apparatus is sent to the information center 11, the information center 11 can retrieve and act on a past purchase history.

In the above description, information exchange between the navigation apparatus 10 and the information center 11, e.g., internet server, is performed by electronic communication. Alternatively, a card or the like is sold in which map data access right information relating to an area size or a particular area is stored and the particular area is opened when the user inputs the purchased card into his navigation apparatus. In this case, the navigation apparatus 10 is equipped with a card slot. When the card is inserted into the card slot, map data access right information such as a key code is read and map data corresponding to the area is opened. A card seller generates a key code based on identification of a navigation apparatus and other information given by a user, and stores the generated key code in a card. Cards can be generated easily by registering pieces of identification information etc., for users of navigation apparatuses in a host computer of the card seller. Other modifications are made possible by allowing the navigation apparatus 10 to capture map data access right information.

In yet another alternative, all or part of the map data is rendered usable for a prescribed period of time after the date of purchase of the navigation apparatus 10 and access to that map data is prohibited after lapse of the prescribed period without payment of a fee. The user selects the map data to be opened for the prescribed period by using the above-described method (area opening process). In this case, the navigation apparatus 10 is equipped with a clock or acquires time information from a GPS device that is connected to the navigation apparatus 10, and the navigation apparatus 10 measures one week of time, for example. In this manner, the user is given a free trial period, during which he can select map data for an area which he actually wants to use.

As shown in FIG. 5, a current map database for Europe is stored in a CD in a manner divided into national regions, that is, France; Holland, Belgium, and Luxembourg; Germany; and Switzerland, Austria, and Italy, etc. Therefore, a user needs to purchase two or three CDs depending on his contemplated range of travel. For example, a person living in Belgium or Luxembourg needs to also purchase map data for Germany or France. Even in this case, what the user actually needs is map data for the eastern part of France or western part of Germany, and not map data for all of France or Germany. Although generating a CD containing map data for Belgium plus the western part of Germany or eastern part of France is technically possible, it is not realistic because of problems relating to the fixed cost and distribution. The large increase in data capacity made available by advent of the DVD has attained a great advancement toward solution of this problem. However, because database development cost is increasing and a database containing all information contains not only information useful to the user but also information not useful, the DVD selling price turns out to be expensive for the user who uses only a part of data.

In view of the above, in this embodiment, conditional access is provided. The conditional access software permits access to only part of the data contained on a large-capacity data medium (DVD). The conditional access allows a user to purchase a right to use only data for that area needed by the user.

An area selection method for this purpose will now be described below.

With reference to FIG. 6 which shows one example by which a user can specify an arbitrary use area by a rectangle. As shown in FIG. 6, a rectangle (or a square) of a predetermined size is prepared is displayed on a map, and a user can freely change its position. The user sets a map data use area by positioning of the rectangle A through use of a conventional input device. A data use fee is determined by the size of the rectangle. Alternatively, a data use fee may be determined by the size of a rectangle whose aspect ratio is variable. In yet another alternative, fees are set different for different regions, taking into consideration the road situations and congestion and a fee is determined dependent upon which regions are included in the area that has been set by the user.

An area may be set in such a manner that a user sets a map data use fee in advance and a rectangle having a prescribed size, determined by the amount of the user fee thus set, is presented to the user and set as an open area. In a further alternative, a user sets a map data use fee in advance and an upper limit value is set for an expandable square, depending on the use fee thus set when the user sets a map data open area by freely determining the size of a rectangle. That is, a certain use fee is set in advance and the user is prevented from expanding the rectangle past a certain size. The size of the rectangle is determined by, for example, dragging the diagonal of a rectangle through the input device. An open area is set by the user freely positioning the rectangle the ratio for which has been set in the above manner.

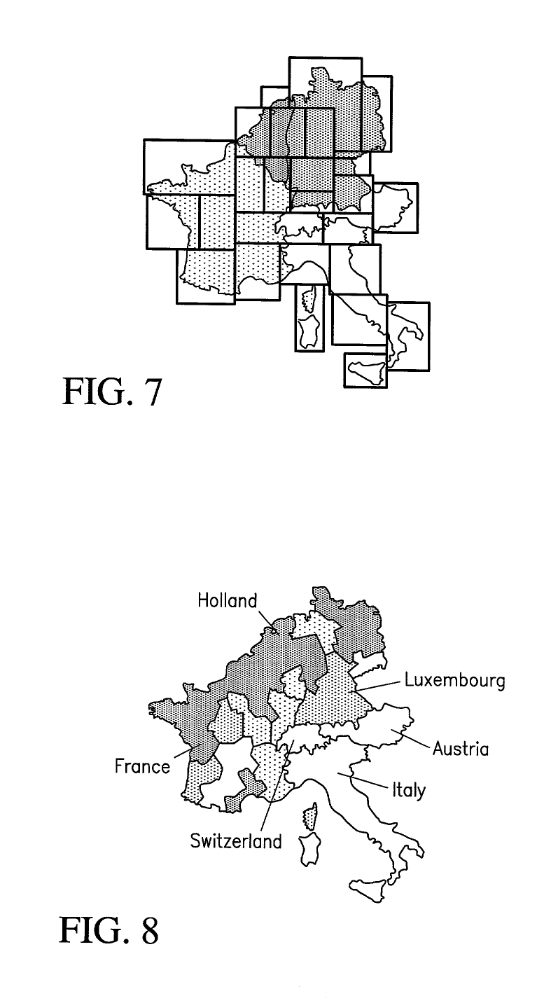

FIG. 7 shows an example in which the entire area is divided in advance and a use area is selected from among the divided areas. As shown in FIG. 7, the entire data range is divided in advance into a plurality of rectangles having different sizes and aspect ratios. A portion of these rectangular areas are selected in a number (e.g., five) that is predetermined depending on the fee the user pays. Use fees may be set for the respective rectangles and a user may be allowed to purchase map data of a desired number of rectangles depending on the fee he pays. In this case, the use fees that are set for the respective rectangles may be displayed on a map for area selection so that a user can easily recognize the use fees of the respective rectangles. It is also possible to divide the entire map area with curved lines, circles, etc; however, it takes a longer time for the navigation system to operate within the confines caused by division in such a manner and hence the response speed is lowered. Therefore, division into rectangular use areas is preferred.

Further, in area selection, if, among the areas selected a remote area is selected, the selected data turns out to be inconvenient for the user because of unavailability of a network between areas. To prevent this inconvenience, a main area may be determined and used to recommend to the user an area bordering on the determined area; and the user may obtain advice about effective use of the database from the screen display thereof.

FIG. 8 shows an example in which boundaries of administrative districts are utilized as area boundaries. As shown in FIG. 8, a small country itself is made one area and a large country is divided into areas corresponding to administrative districts. A user is allowed to select a desired number of areas dependent on the fee he pays. To simplify the navigation program, all areas may correspond to countries rather than smaller administrative districts. Even in this example, if boundaries of administrative districts were used as they are, there would be areas having curved boundaries would which lower the responsiveness of the navigation processing as described above. Therefore, in practice, it is desirable to approximate each administrative district by a combination of rectangles having proper sizes. While the area is divided according to its size in the above description, the area also may be divided according to its population. Specifically, since an area with large population includes a large number of houses, the number of roads increases accordingly. This suggests that population and the number of the buildings searched by the navigation apparatus 10 are proportional to each other. Therefore, if the area may be divided according to population, also the amount of data may be equally divided for areas stored in a database.

Area judgment, which determines the confines relating to a use area is preferably made as late as possible in execution of the navigation routine in order to minimize reduction in performance due to the introduction of the area selecting function which is an important feature of the invention. Otherwise, in the conditional access that provides the user with the advantage that the user is required to pay for only that map data for a region which the user selects, the navigation system might perform various operations within the confines relating to a use area, as a result of which the processing load may increase, thus lowering the performance. Unduly low performance lowers the value of the product. In view of this, the use area is judged at as downstream a position as possible in the flow of navigation processing, to minimize influence of the conditional access on the navigation processing. In this embodiment, data for unselected areas is not merely prohibited from use; instead, a user is urged to purchase a copyright of a wider range by informing the user of possession of such information though not providing him with the contents.

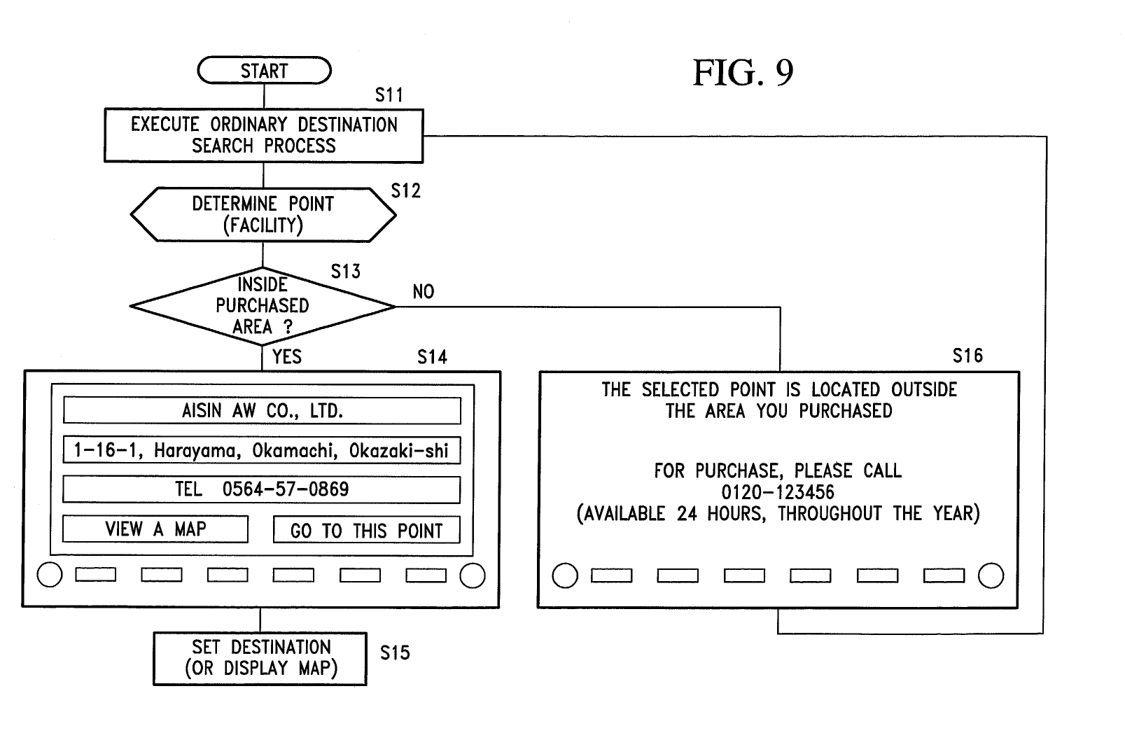

FIG. 9 is a flowchart showing an example of a navigation routine in which a warning is given before facility information is displayed for guidance.

A destination that has been input by the user is searched for based on its coordinates (point data) in the usual manner, that is, by using all data instead of only that data for the purchased area (step S11), and a point (facility) corresponding to the destination is determined (step S12). Then, it is judged whether the determined point is located inside or outside the purchased area (step S13). If the determined point is located inside the purchased area, a facility name, an address, a telephone number, etc. of the destination are displayed and the user is urged to select “View a map” or “Go to this point” by manipulating a corresponding button (step S14). The destination is set or a related map is displayed in accordance with the button manipulated, e.g., clicked on, by the user (step S15). If it is judged at step S13 that the point determined for the destination is located outside the purchased area, a warning such as “The selected point is located outside the area you purchased. For purchase, please call 0120-123456 (available 24 hours, throughout the year).” is displayed to urge the user to purchase a copyright for data of a wider range (step S16). Given this warning, the user realizes that the destination is located outside the purchased area. The user can then have the process be restarted from step S11.

Thus, a destination search is performed in the usual manner and the judgement that the destination is inside/outside the purchased area is made only after the location of the destination has been finally determined. As a result, not only can reduction in performance be minimized but also it causes the user to recognize that the needed but currently inaccessible information is stored in the database and urges the user to purchase a copyright for data of a wider range. Some users may think that the judgement of inside/outside the purchased area is better performed at the time of setting a destination because the process can be restarted earlier. Therefore, in another embodiment the inside/outside judgment is performed at step S11 and a warning like the one given at step S16 in the process of FIG. 9 is given thereafter if the destination is determined to be at a point located outside the purchased area.

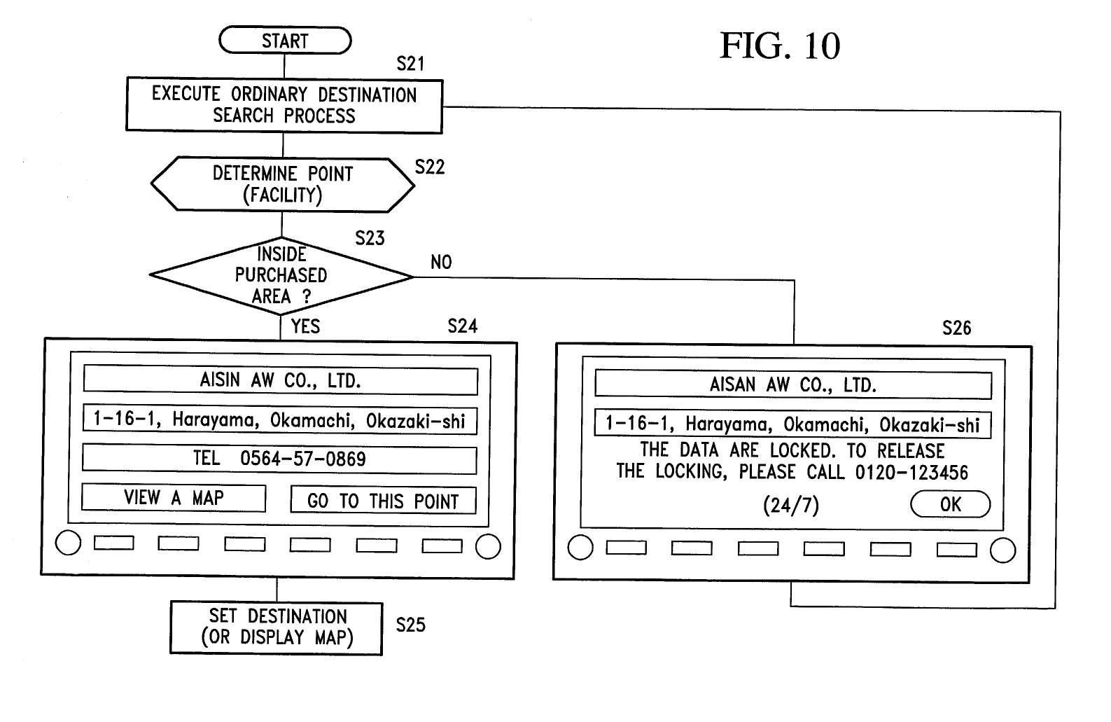

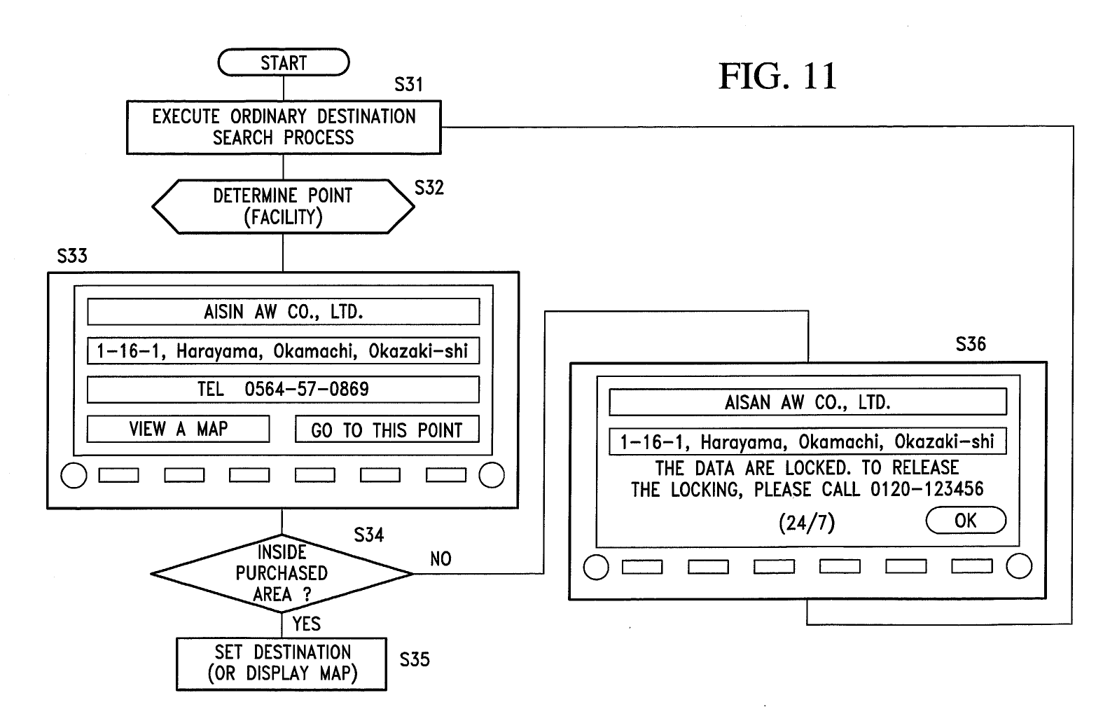

FIGS. 10 and 11 are examples in which a destination search is performed in the usual manner and a data lock warning is given while all or part of facility information for a destination is displayed, to cause the user to recognize that the relevant information is stored in the database, but is currently inaccessible, and to urge the user to purchase a copyright for data of a wider range. FIG. 10 is a flowchart showing a routine in which a warning is given while part of the facility information is displayed. This example is the same as the example of FIG. 9 except that part of facility information and an OK key for release of data locking are displayed in this example.

First, a destination is input and a conventional destination search process is executed using all data in the storage medium (step S21). Then, the point location (facility) of the destination is determined based on coordinate data for the destination (step S22), and it is judged whether the determined point is located inside or outside the purchased area (step S23). If the determined point is located inside the purchased area, a facility name, an address, a telephone number, etc. of the destination are displayed and the user is urged to select “View a map” or “Go to this point” by manipulating a corresponding button (step S24). The destination is set or a related map is displayed in accordance with the button manipulated by the user (step S25). If it is judged at step S23 that the determined point is located outside the purchased area, part of the facility information such as the facility name and the address of the destination is displayed, along with a warning such as “The data is locked. To release the lock, please call 0120-123456.” and an OK key for acceptance of this proposal is also displayed (step S26). If the user manipulates the OK key, the process returns to step S21, to execute the destination setting process again. The user who wants to have the data lock released acquires a key code by the above-described method and has the data lock released.

FIG. 11 shows a routine in which a warning is given after all of facility information has been displayed. First, a destination is input and the usual destination search routine is executed by using all the stored data (step S31). Then, the point (facility) of the destination is determined based on the coordinates of the destination (step S32), and a facility name, an address, a telephone number, etc. of the destination are displayed (step S33). Then, it is judged whether the determined point is located inside or outside the purchased area (step S34). If the determined point is located inside the purchased area, the destination is set or a related map is displayed automatically (step S35). If it is judged at step S34 that determined point is located outside the purchased area, all of the facility information such as the facility name and the address of the destination is displayed, along with a warning sentence such as “The data is locked. To release the lock, please call 0120-123456.” and an OK key for acceptance of this proposal is also displayed (step S36). If the user manipulates the OK key, the process returns to step S33, to again execute the destination setting process again. Alternatively, the system may be configured in such a manner that a data lock release request is transmitted to the information center 2 automatically upon manipulation of the OK key.

Although the above examples are directed to a destination setting, it goes without saying that the invention is not limited to such a case. For example, the invention can also be applied to the displaying a map of a point (facility) and its vicinity after a point search in a map display apparatus. In this case, if it is found that the facility which is the subject of search is located outside an open area, a warning to that effect is given.

Incidentally, if an area inside/outside judgment is performed during execution of a search process, not only is the performance of the navigation apparatus 10 lowered until completion of the search, but also there is the possibility that an improper (rather than optimum) route will be determined because of area restriction. Accordingly, it is preferred to perform a search in a manner disregarding the area restriction and to perform an area inside/outside judgment based on the results of the search.

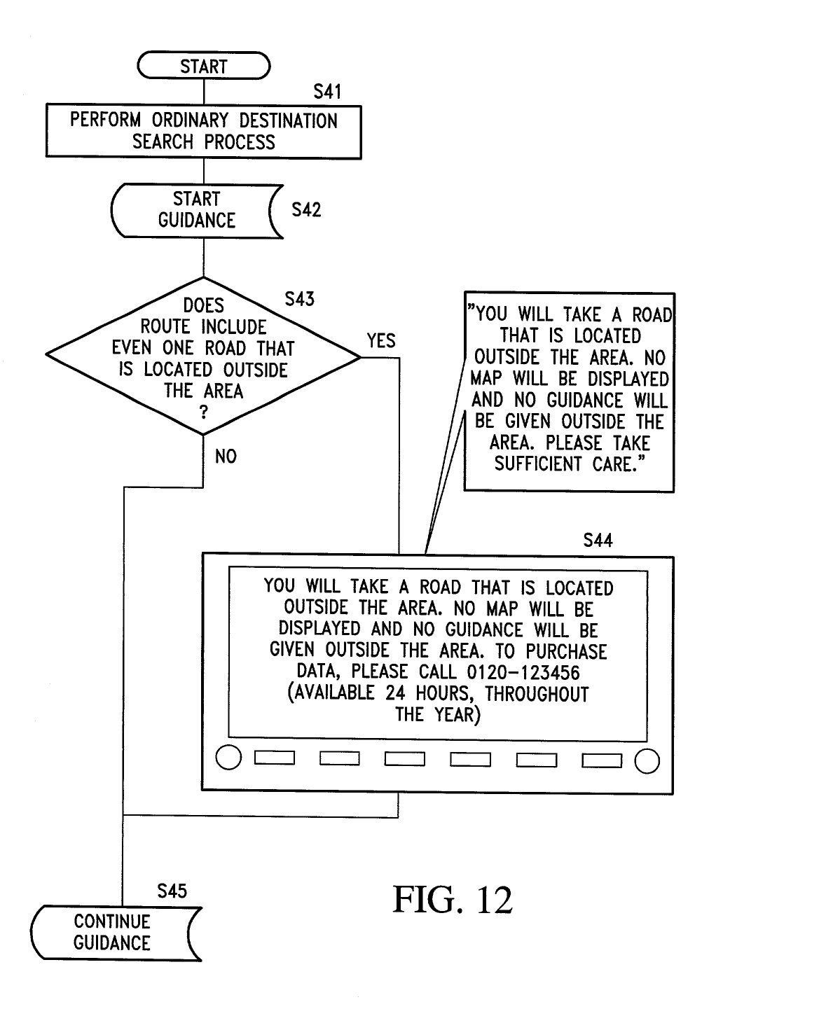

FIG. 12 shows a routine in which an area check is performed after a destination search and first voice guidance. In this example, destination setting and a route search are performed utilizing all stored data and an area check is then performed at the stage of outputting guidance. First, an ordinary destination search is executed (step S41) and guidance is started (step S42). Then, it is judged whether the route includes even one road that is located outside the area (step S43). If there exists no such road, the guidance is continued (step S45). If there exists even one road that is located outside the area, a message such as “You will take a road that is located outside your selected area. No map will be displayed and no guidance will be given outside the area. To purchase data for the additional area, please call 0120-123456 (available 24 hours, throughout the year).” is displayed and a voice warning such as “You will take a road that is located outside your selected area. No map will be displayed and no guidance will be given outside the area. Please take sufficient care.” is issued (step S44) and guidance is continued at step S45.

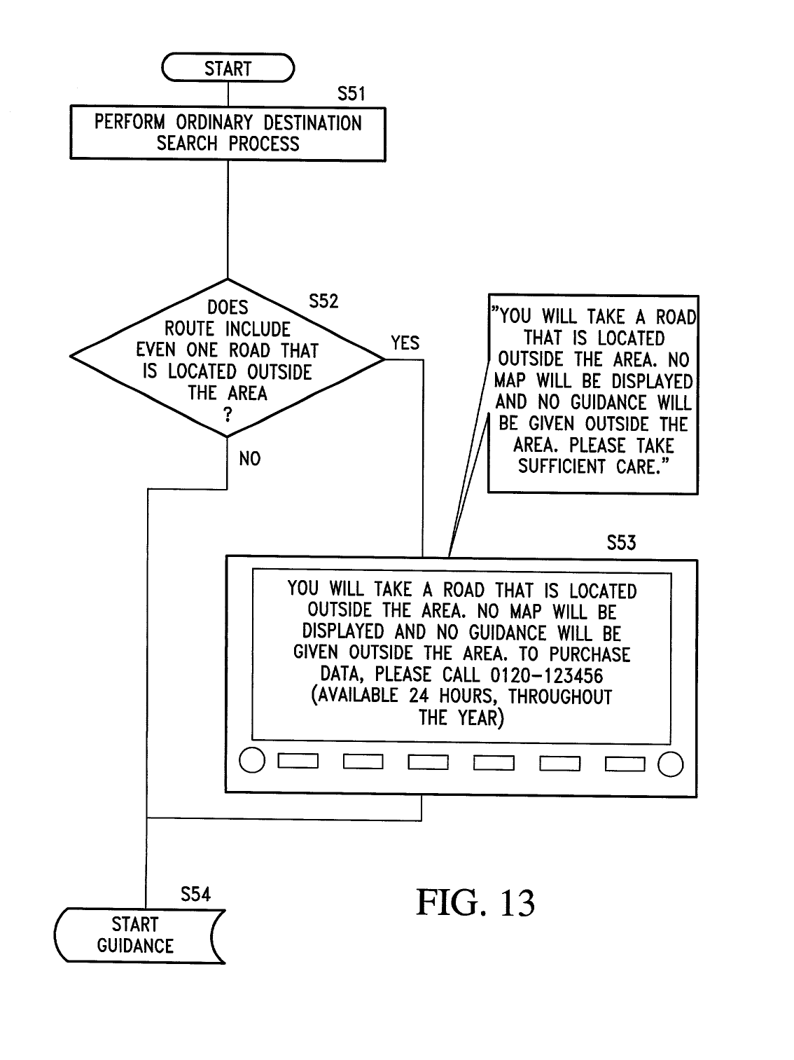

FIG. 13 is a flowchart showing an example of a routine in which an area check is performed after completion of a destination search. First, an ordinary destination search process is executed (step S51). Then, it is judged whether or not the route includes even one road or road section that is located outside the area (step S52). If there exists no such road, guidance is started (step S54). If there exists even one road or road section that is located outside the area, a message is displayed and a voice warning is issued as exemplified above in connection with S44 and guidance is started at step S54.

FIG. 4 illustrates one example of a map display routine in which a judgment as to whether or not data to be read into the navigation apparatus 10 corresponds to an area located entirely within the open (selected) area (area for which a fee has been paid), which judgement is made before the data is read into the apparatus 1. When the user makes a map display request (step S61), the navigation apparatus 10 judges whether or not data to be read into the apparatus 1, i.e., all data for a route obtained by a search is located inside or outside the open area (step S62). If all the data is located inside the area, the data is read into the apparatus 10 in an ordinary manner (step S63). If there is data for any area that is located outside the open area, only data inside the open area is read into the apparatus 10 (step S64). Then, a map is displayed based on the data that has been read into the apparatus 10 (step S65). In this manner, the area inside/outside judgment is performed at the stage of reading data into the central processing unit from the information storage device 3 (DVD) and only map data inside the open area is read into the central processing unit. Another configuration is possible in which all map data is read into the central processing unit from the information storage device 3, receiving a DVD or like storage medium, and an area inside/outside judgment is performed at the stage of outputting guidance information through the output device so that only map data inside the open area is output through the output device. The map display request may be either one that requests display of a map after a route search or one that requests only display of a map without setting of a route.

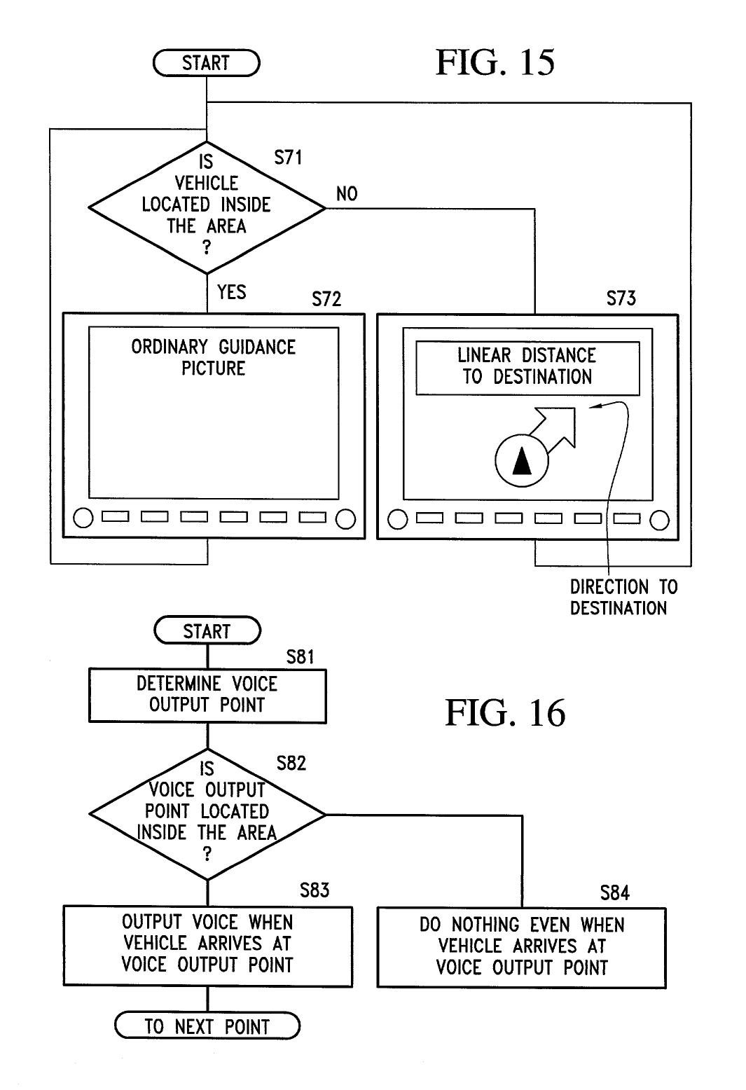

FIG. 15 is a flowchart which illustrates one example of a routine in which guidance information is provided only when the user's vehicle is located inside the open area. After a route search has been performed using all data contained in the storage medium, it is judged whether the user's vehicle is located inside the open area (step S71). If the vehicle is located inside the open area, an ordinary guidance screen is displayed (step S72). If the vehicle is located outside the open area, no map is displayed and only a linear distance to the destination and an arrow indicating the direction to the destination are displayed (step S73). Alternatively, only one of the linear distance to the destination and the direction to the destination may be displayed or voice-output.

FIG. 16 is a flowchart showing an example of a routine determining whether or not the coordinates of a voice output point for voice guidance are located inside or outside the open area and outputting the voice guidance only when that point is determined to be within the open area. First, a voice output point for voice guidance is determined (step S81). It is then judged whether or not the voice output point is located inside the open area (step S82). If the voice output point is located inside the open area, a voice message is output (voice guidance) when the user's vehicle arrives at the voice output point (step S83). If the voice output point is located outside the open area, nothing is done even when the user's vehicle arrives at the voice output point (step S84). As described above, guidance information associated with map data of the open area and that associated with map data of a region outside the open area are output in different manners, which makes it possible to urge the user to expand the open area.

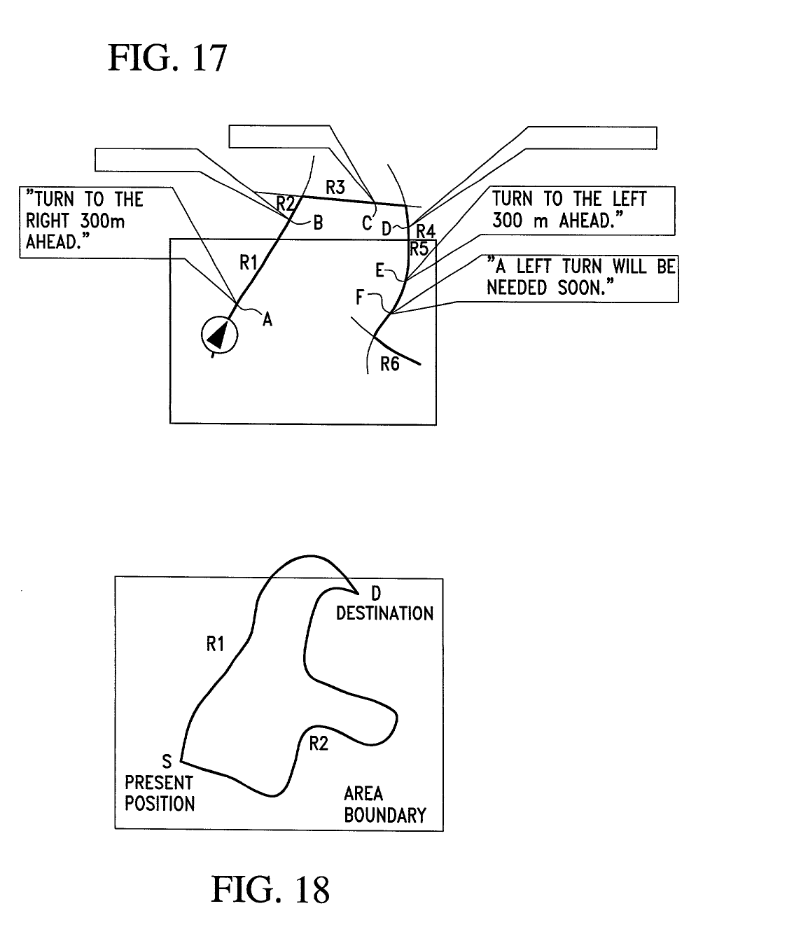

FIG. 17 shows a specific example of application of the routine of FIG. 16. It is assumed that a rectangular frame indicates an area boundary, a guidance route R1-R6 has been obtained by a search, a route section R2-R4 is located outside the area, and characters A-F denote voice output points. Guidance “Turn to the right 300 m ahead.” is given at the voice output point A on the route section R1. No voice guidance is given at the voice output points B, C, and D on the respective route sections R2, R3, and R4. Guidance “Turn to the left 300 m ahead.” is given at the voice output point E on the route section R5. Guidance such as “A left turn will be needed soon.” is given at the voice output point F. Not only is it judged whether or not voice output points are located inside or outside the open area but also whether or not display output points for intersection enlarged views (e.g., points 300 m before guidance intersections) are located inside or outside the open area, so as to display the intersection enlarged views only for those display output points within the open area.

If a route from the present position to the destination that has been obtained by a search includes a section that is located outside the open area, a further search may be performed using only the map data for the open area to find a second route that does not include any roads located outside the open area and route information for the second route may be presented to the user. For example, assume that, as shown in FIG. 18, a route R1 has been obtained as the best route from a present position (start point) S to a destination D by a search using all data. However, detailed guidance is not given in a route section that is located outside the open area, because route guidance is restricted there. In this case, if a second route R2 is found by a search using only the map data of the open area, the user can choose, through comparison, between the best route R1 and the second route R2 that is not the best one but for which detailed guidance can be given. As for route information, the entire route obtained by a search may be displayed or only such information as the names of roads along the obtained route and expressway tolls may be displayed.

In each of the above examples, a map-data-open area is specified by a rectangle, a country, or administrative district. However, the system may be so configured that a map type (e.g., a wide area map, a detailed map, or a city map) and/or service level, e.g., only map display or map display plus guidances, can be designated in accordance with a use fee. This makes it possible to set an area that is more suitable for a user's purposes such as display only in France, display plus guidance in Germany, and additional display of a city map in Italy.

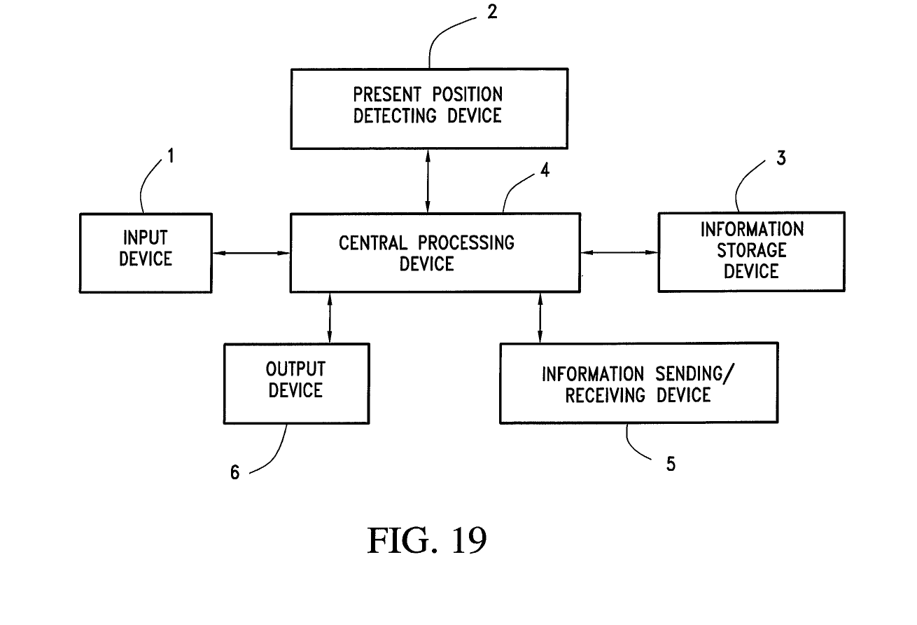

An example of a navigation apparatus incorporating an accounting system according to the invention is shown in FIG. 19. The navigation apparatus of FIG. 19 is composed of an input device 1, a present position detecting device 2, an information storage device 3, a central processing unit 4, an information sending/receiving device 5, and an output device 6. The input device 1 is used for inputting a point to be searched for and information relating to route guidance. The present position detecting device 2 detects information relating to the present position of the vehicle that is mounted with the navigation apparatus. The information storage device 3 contains navigation data necessary for route searching/determination, display/voice guidance data necessary for route guidance, programs (application programs and/or an OS), etc. The central processing unit 4 performs route search processing and display/voice guidance processing that is necessary for route guidance, and controls the entire navigation apparatus. The information sending/receiving apparatus 5 sends and receives information relating to running of the vehicle such as road information and traffic information, detects information relating to the present position of the vehicle, and sends and receives information relating to the present position of the vehicle. The output device 6 outputs a point input screen and information relating to route guidance.

The input device 1 has functions of allowing the driver to input a start point and a destination, allowing the driver to specify an area of map data he wants to use and to input an area size, and, based on the driver's input, instructs the central processing unit 4 how to perform navigation processing. For example, the input device 1 may include a touch switch through which a destination is input in the form of an address, a telephone number, coordinates on a map, or the like, a touch switch for input of a request for route guidance, and a remote controller such as a JOG dial. In this embodiment, equipped with a device that enables a voice-input dialogue, the input device 1 also functions as a voice input device. The input device 1 may additionally be equipped with a card reading device for reading data from an IC card or a magnetic card. Further, the input device 1 may additionally be equipped for data communication by exchange of data with a remote information source such as an information center that stores data necessary for navigation and provides information over a communication channel upon request from the driver or with a portable electronic apparatus having map data, destination data, simplified map data, and/or map data including building shapes.

The present position detecting device 2 is a device that acquires information as to the present position of the vehicle, for example, using the global positioning system (GPS), an absolute beating sensor that detects direction of movement of the vehicle in the form of an absolute bearing by utilizing the earth's magnetism, for example, a relative bearing sensor that detects direction of movement of the vehicle in the form of a relative bearing by utilizing a steering sensor, a gyro sensor, or the like, or a distance sensor that detects running distance of the vehicle based on the number of rotations of a wheel, for example.

The information storage device 3 is an external storage device containing navigation programs and data and may be a CD-ROM, a DVD-ROM, or the like. A unique serial number such as a production number is set in the information storage device 3. Specifically, the information storage device 3 contain s programs to be used for providing functions such as route guidance, a program corresponding to the flowcharts described herein, programs for display output control necessary for route guidance and for interactive guidance with voice input and data necessary therefor, and programs for voice output control necessary for voice guidance and data necessary therefor. The information storage medium 3 contains, in the form of files, map data that includes search data, e.g., destination data, registered point data, road data, and data classified by genre, for use in route searching, and other guidance/display data, e.g., guidance data used for route guidance, display data to be used in displaying a map, and map matching data to be used in determining the present position. The information storage medium 3 contains all data necessary for operation of the navigation apparatus as well as the edition number of the map data. The invention can also be applied to a navigation apparatus of a type wherein only data is stored in a CD-ROM and programs are stored in the central processing unit.

The central processing unit 4 is equipped with a CPU, a flash memory, a ROM, and a RAM. The CPU executes various routines such as route searching, route guidance information output control, control of information to be output through the output device 6, generation of an ID unique to the navigation apparatus based on the serial number of the information storage device 3 and the edition number of the map data when receiving an instruction to expand the open map area, and determination of a data-usable (open) map area, such as an area size, responsive to receipt of a key code corresponding to the ID unique to the navigation apparatus that is sent from the information center 11. The flash memory reads a program from the CD-ROM in the information storage device 3 and stores it. The ROM contains programs (program reading means) for checking and updating a program stored in the flash memory. The RAM temporarily stores route guidance information obtained by a search such as coordinates of a set destination and a road name code number or data being used in processing by the central processing device (CPU) 4. CPU 4 is also equipped with other devices (not shown) that include a speech processor for dialogue including voice input through the input device 1 and for combining, a voice, a phrase, a set of sentences, a sound, etc. that have been read from the information storage device 3 based on an audio output control signal from the CPU, converting a resulting audio signal into an analog signal, and outputting the analog signal through a speaker, a communication interface for exchanging input/output data by electronic communication, a sensor input interface for capturing a sensor signal from the present position detecting device 2, and a clock to be used for attaching a date and time to internal dialogue information. The above-mentioned program for updating may be stored in the information storage device 3.

All of the programs relating to the invention and the programs necessary for navigation may be stored in the CD-ROM as an external storage medium. Alternatively, all or part of these programs may be stored in the ROM in the main body. Data and programs stored in the external storage medium are input, as external signals, to the central processing unit of the navigation apparatus main body and processed therein to realize various navigation functions.

Alternatively, all or part of the programs relating to the invention, the other programs necessary for navigation, and the map data may be sent to a plurality of base stations (Internet provider terminals and communication stations that communicate with vehicles) from an information center (an Internet server or a navigation server). In this case, the central processing unit 4 of the navigation apparatus would receive, through the information sending/receiving device 5, information that is sent from a base station, download it to a readable, writable memory (e.g., the RAM, the flash memory, or the hard disk drive) of the central processing unit 4 and execute the programs. Here, the programs and the map data may be stored in different readable and writable memories. For example, the programs and the map data may be stored in the flash memory and the RAM, respectively. Or the programs and the map data may be stored in the same readable and writable memory. As a further alternative, all or part of the programs and the map data may be sent from an information center to a home personal computer, and the home personal computer would then download to a removable storage medium, e.g., a memory stick or a floppy disk. In this last alternative, the storage medium would be connected to the central processing unit 4 for execution of the programs stored therein.

In the embodiments described above, the navigation apparatus is equipped with the flash memory having a relatively large capacity into which a program, supplied from the CD-ROM of the information storage device 3 or downloaded from an information center or the like, is read and the ROM contains a program (program reading means) to be used for starting the CD-ROM. The flash memory holds the stored information even after shutoff of the power to it; that is, it is a nonvolatile storage medium. The program (program reading means) in the ROM is activated, and by using this program a program stored in the flash memory is checked and disc management information, etc. of the CD-ROM in the information storage device 3 are read into the central processing unit 4. The program loading processing (updating processing) is performed with a judgment based on the disc management information and the state of the flash memory.

The information sending/receiving device 5 is composed of a GPS receiver for acquiring present position information, date/time information, etc. using the global positioning system (GPS), a VICS information receiver for acquiring traffic information etc. using FM multiplex broadcast, radio beacons, optical beacons, or the like, and a data sending/receiving device for exchanging information bidirectionally with an information center (as in ATIS) or another vehicle using a cellular phone, a personal computer, or the like.

The output device 6 functions to output guidance information in the form of voice and/or image when the driver needs it and to print, for example, data that has been navigation-processed by the central processing device 4. The output unit 4 is equipped with means for those purposes such as a display device for displaying input data and a route guidance picture, a printer for printing data that has been processed by the central processing unit 4 and data stored in the information storage device 3, a speaker for outputting route guidance in voice form, and other devices.

The display device is a simple liquid crystal display device or the like, and displays map data to be processed by the central processing unit 4, an area selection menu picture, an enlarged view of an intersection (based on guidance data), an enlarged view of a branch point, a current route along which the vehicle is traveling, a route newly obtained by a search, information relating to the destination of each route, a destination name, time, and distance, an arrow showing a direction of movement, an image of a personified character, etc. Since image data sent to the display device is binary data (bit map data), it is sent via a communication line as used in serial communication or the like, rather than a dedicated image signal line. Alternatively, a separate (dedicated) communication line may be used for this purpose. The display device is equipped with a memory for temporarily storing bit map data.

The display device is incorporated into an instrument panel that is located in the vicinity of the driver's seat. Looking at the display device, the driver can recognize the present position of the vehicle and obtain information on the route. The display device may be equipped with a tablet such as a touch panel or a touch screen so that area input, area selection, key code input, point input, road input, etc. can be performed by touching the screen or moving a fingertip, for example, on the screen. In this embodiment, search history information, e.g., an address and a telephone number, that has been input through a search screen and information indicating links between screens of a series from an initial search screen to an input-ongoing search screen, is stored in the RAM while the vehicle is stopped. Transition is made from the search screen to a point setting screen or a present position map screen when the vehicle starts, depending on a result of a search that has been performed based on the stored data content, and the stored input-ongoing search screen is recovered when the vehicle stops again. This operation prevents use of a search screen from becoming unduly complex.

Thus, overall operation of the navigation apparatus involves the reading of programs into the central processing unit 4 from the information storage device 3 and activation of a route guidance program. The present position is detected by the present position detecting device 2 and a map of the vicinity of the present position, as well as a present position name, etc., are displayed. Then, a target destination is set by input of a name such as a place name or a facility name, a telephone number or an address, registered point, or a road name, and a route from the starting position to the destination is searched for. Once a route has been determined, route guidance is performed while present position is traced by the present position detecting device 2.

As is apparent from the foregoing description, in accordance with the present invention, the price of map data to be input to a navigation apparatus is varied depending on the area of map data the user wants to use. Therefore, the user is required to pay for only that area map data he wants to use, and hence can use the map data at a reduced cost. Further, the user can expand (open), when necessary, the area of map data he wants to use. A map data provider can easily urge users to expand map data use ranges.

Conventionally, a user is obliged to purchase a database without knowing its content. In contrast, as described above, the present invention allows users to use, at first, a portion of the entire data at a small fee, after selecting that portion and then to purchase data for another area after checking the contents of that first data portion. A user can use map data at a reduced cost because he is required to pay only for that map data area he wants to use. This also allows a map data provider to easily urge users to expand map data use ranges. Further, communication with a navigation apparatus or an information center by means of a personal computer, a cellular phone, or PDA makes it possible to open an area even if the user is not in the vehicle.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A method for accessing map data for navigation, comprising:
providing map data encoded on a storage medium;
purchasing an access right to at least a portion of the encoded map data; and
opening said at a least portion of the encoded map data to access by a navigation program in accordance with the purchased access right.

2. An accounting method for control of map data to be input to a navigation apparatus, comprising:
providing map data encoded on a storage medium;
paying a use fee for access right to at least a portion of the encoded map data;
opening that map data for which the user fee has been paid, only the opened map data being available for use by the navigation apparatus.

3. The accounting method according to claim 2, wherein a plurality of use fees are set for respective areas.

4. The accounting method according to claim 2 wherein a plurality of use fees are set for respective, but different area sizes.

5. The accounting method according to claim 2, further comprising:
generating identification information within the navigation apparatus;
communicating the identification information to a facility in the form of an internet server, a customer server, or a remote information center; and
responsive to receipt of the identification information, issuing access right information describing the access right from the facility to the navigation apparatus.

6. The accounting method according to claim 4, wherein the map data access right information is a key code that is generated based on the identification information, and wherein said opening of map data is controlled based on the key code.

7. The accounting method according to claim 4, wherein the identification information is generated based on information of the area corresponding to the map data to be opened, the identification information, and map data edition information.

8. The accounting method according to claim 7, wherein the identification information is a serial number of storage means of a single navigation apparatus, said serial number being unique to said single navigation apparatus, and the map data edition information is a number unique to an edition of a database stored in the storage means.

9. A data storage medium containing, encoded thereon, a program for generating identification information unique to a navigation apparatus, generating map data edition information, determining a map data use area based on map data access right information that is generated based on the unique identification information and opening for use by the navigation apparatus only map data corresponding to the determined map data use area.

10. A navigation system which provides navigational guidance based on stored map data, comprising:
a navigation apparatus comprising:
storage means for storing the map data;
input means for inputting area information indicating map data to be opened;
communication means for sending the area information and identification information unique to the navigation apparatus to a remote information center; and receiving means for receiving information from the remote information center; and
the remote information center comprising:
means for receiving the area information and the identification information unique to the navigation apparatus from the navigation apparatus; and
access right means for generating data access right information based on the received area information and identification information unique to the navigation apparatus,
wherein the navigation apparatus opens all or part of the map data for use in providing the navigational guidance, based on the data access right information received from the information center.

11. The navigation system according to claim 10, wherein the navigation apparatus further comprises means for generating the identification information unique to the navigation apparatus.

12. The navigation system according to claim 11, wherein the identification information unique to the navigation apparatus is generated based on identification information for the navigation apparatus and map data edition information.

13. The navigation system according to claim 10, wherein the area information is an area size, wherein the data access means generates the data access right information in accordance with the area size, and wherein the navigation apparatus further comprises selecting means for selecting an area in accordance with the area size responsive to receipt of the data access right information.

14. The navigation system according to claim 10, wherein the area information is a specified area, wherein the data access right generating means generates data access right information corresponding to the specified area, and wherein the navigation apparatus opens map data only for the specified area responsive to receipt of the data access right information.

15. The navigation system according to claim 10, further comprising accounting means for settling a bookkeeping account in accordance with the opened map data.

16. The navigation system according to claim 15, wherein the accounting means settles the account based on the data access right information.

17. A navigation method for providing navigational guidance based on stored map data, comprising the steps of:
in a navigation apparatus, receiving area information indicating map data to be opened for use, and sending the area information and identification information unique to the navigation apparatus to a remote information center;
at the remote information center, receiving the area information and the identification information unique to the navigation apparatus from the navigation apparatus, generating data access right information based on the received area information and identification information and sending the generated data access right information to the navigation apparatus; and
in the navigation apparatus, opening map data only to an extent in accordance with the data access right information received from the center.

18. An information center which sends and receives data to and from a navigation apparatus, comprising:
means for receiving area information and identification information unique to the navigation apparatus from the navigation apparatus;
means for generating, based on the received area information and identification information, data access right information to be used for opening map data for use in the navigation apparatus; and
means for sending the generated data access right information to the navigation apparatus.

19. A navigation apparatus which provides navigational guidance based on stored map data, comprising:
input means for inputting area information indicating an area for which map data is to be opened;
communication means for sending the area information and identification information unique to the navigation apparatus to a remote information center;
receiving means for receiving, from the information center, data access right information that has been generated at the information center based on the area information and the identification information; and
means for opening the map data for use in providing the navigational guidance, only to an extent in accordance with the data access right information.

20. A navigation apparatus for providing navigational guidance based on stored map data, comprising:
storing means for storing map data; and
area setting means for opening for use in providing the navigational guidance, only part of the stored map data as a rectangular open area.

21. The navigation apparatus according to claim 20, wherein said area setting means determines a size of the rectangle in accordance with a use fee.

22. The navigation apparatus according to claim 20, wherein the area setting means changes an aspect ratio of the rectangle in accordance with a use fee.

23. The navigation apparatus according to claim 20, wherein the area setting means changes an aspect ratio of the rectangle in accordance with a use fee.

24. A navigation apparatus for providing navigational guidance based on stored map data, comprising:
storing means for storing map data;
fee setting means for setting a use fee for use of the map data; and
area setting means for setting, as an open area of data available for use in providing the navigational guidance, only part of the stored map data, the open area of the stored map data being limited to a range corresponding to the use fee.

25. The navigation apparatus according to claim 24, wherein the area setting means sets the open area as a rectangle having a size that corresponds to the use fee.

26. The navigation apparatus according to claim 24, wherein the area setting means changes an aspect ratio of the rectangle in accordance with the use fee.

27. A navigation apparatus which provides navigational guidance based on stored map data, comprising:
storing means for storing map data for a plurality of respective areas; and
area setting means for selecting areas of a number corresponding to a use fee and for opening map data corresponding to the selected areas for use in providing the navigational guidance.

28. The navigation apparatus according to claim 27, wherein a price for opening map data is set for each of the plurality of areas.

29. The navigation apparatus according to claim 28, wherein the price is set in accordance with either an amount of map data associated with the selected areas or a square measure of the selected areas.

30. The navigation apparatus according to claim 27, wherein each of the plurality of areas has a rectangular boundary.

31. The navigation apparatus according to claim 27, wherein each of the plurality of areas has a boundary that is a boundary of a country or administrative district.

32. The navigation apparatus according to claim 31, wherein each of the plurality of areas has a boundary made to correspond to a boundary of a country or boundaries of administrative districts depending on their square measure.

33. The navigation apparatus according to claim 32, wherein each of the plurality of areas is approximated by a combination of rectangles.

34. A terminal for data communication to and from a remote information center, said terminal comprising:
input means for inputting identifying information unique to a navigation apparatus and map-data-open area information,
means for transmitting the identifying information and the area information to the information center; and
means for receiving data access right information, based on the identifying information and the area information, from the information center.

35. A terminal for data communication to and from a remote information center and a navigation apparatus, said terminal comprising:
means for receiving identifying information unique to the navigation apparatus from the navigation apparatus;
means for inputting map-data-open area information;
means for transmitting the identifying information and the area information to the information center; and
means for receiving data access right information, based on the identifying information and the area information, from the information center.

36. A data storage medium containing, encoded thereon, a program performing navigation processing based on stored map data and opening for use in the navigation processing only a portion of the stored map data corresponding to at least one rectangular area.

37. A data storage medium containing, encoded thereon, a program generating a map display based on stored map data and opening for use in the map display generation only a portion of the stored map data corresponding to at least one rectangular area.
